(19) United States
(12) Patent Application Publication
(10) Pub. No.: US 2026/0275712 A1
(43) Pub. Date: Sep. 17, 2026

(54) Continuous Insulation Sheathing with Drainage Embossment

(71) Applicant: Henry Company, LLC, Kimberton, PA (US)

(72) Inventors: Thomas L. Savoy, Prior Lake, MN (US); Divya Chopra, West Chester, PA (US)

(21) Appl. No.: 19/168,503

(22) PCT Filed: Mar. 27, 2024
(86) PCT No.: PCT/US2024/021629

§ 371 Date: Sep. 24, 2025

Related U.S. Application Data
(60) Provisional application No. 63/492,360, filed on Mar. 27, 2023.
(60) Provisional application No. 63/505,711, filed on Jun. 2, 2023.

(51) Int. Cl. E04B 1/70; E04B 1/76; E04B 1/80

(52) U.S. Cl. CPC E04B 1/7038; E04B 1/762; E04B 1/80

(57) ABSTRACT

The invention relates generally to insulation sheathing in interior or exterior wall constructions for residential and business applications. More specifically, the invention pertains to an improved moisture drainage system that prevents waterproofing failure, mold, mildew, and wood rot, associated with conventional wall constructions. Particularly, this invention relates to insulation sheathing combined with a weather-resistive barrier that allows for drainage of moisture in wall construction applications. The product of the present invention comprises an embossed drainage plane on one or both sides of an insulation product, but particularly on the facer side of the lamination. The product may be used as continuous or non-continuous insulation sheathing. This invention also relates to a first insulation sheathing panel, comprising: (iii) an insulation foam layer having an outer surface and an inner surface, and (iv) a first insulation facer having an outer surface and an inner surface, wherein the inner surface of the first insulation facer is adhered to the inner surface of the insulation foam layer; wherein the first insulation facer exceeds the dimension of the insulation foam layer at least at one edge to create an extension flap of the insulation facer, wherein the extension flap further comprises a removably attached release liner attached to the insulation facer's inner surface. This invention also relates to an insulation sheathing system comprising two insulation sheathing panels: a first insulation sheathing panel and a second insulation sheathing panel, wherein the panels are juxtaposed side by side in one plane, wherein each panel comprises either a groove or a tongue at least on one side of the panel.

### CROSS REFERENCE TO RELATED APPLICATIONS

The present application hereby claims the benefit of the provisional patent application of the same title, Ser. No. 63/492,360, filed on Mar. 27, 2023, and provisional application of the same title, Ser. No. 63/505,711, filed on Jun. 2, 2023, the disclosures of which are herein incorporated by reference in their entirety.

### FIELD OF THE INVENTION

The present invention relates generally to insulation sheathing in interior or exterior wall constructions for residential and business applications. More specifically, the invention pertains to an improved moisture drainage system that prevents waterproofing failure, mold, mildew, and wood rot, associated with conventional wall constructions. Particularly, this invention relates to insulation sheathing combined with a weather-resistive barrier that allows for drainage of moisture in wall construction applications. The product of the present invention comprises an embossed drainage plane on one or both sides of an insulation product, but particularly on the facer side of the lamination. The product may be used as continuous or non-continuous insulation sheathing.

This invention also relates to a first insulation sheathing panel, comprising:
(i) an insulation foam layer having an outer surface and an inner surface, and
(ii) a first insulation facer having an outer surface and an inner surface,
wherein the inner surface of the first insulation facer is adhered to the inner surface of the insulation foam layer;
wherein the first insulation facer exceeds the dimension of the insulation foam layer at least at one edge to create an extension flap of the insulation facer, wherein the extension flap further comprises a removably attached release liner attached to the insulation facer's inner surface.

This invention also relates to an insulation sheathing system comprising two insulation sheathing panels: a first insulation sheathing panel and a second insulation sheathing panel, wherein the panels are juxtaposed side by side in one plane, wherein each panel comprises either a groove or a tongue at least on one side of the panel.

### BACKGROUND

The insulation sheathing generally comprises an insulation foam and a facer film.

### SUMMARY OF THE INVENTION

The present invention addresses the above issues of moisture drainage. In the present invention, a vapor semi-permeable, weather-resistive drainage product is created in a single inline process through an embossment method. Particularly, the present invention provides for a vapor semi-permeable insulation sheathing that provides insulation, a weather-resistive barrier, and an air-barrier while providing a drainage mechanism that is formed through pressure and heat. The patterned embossment on the sheathing provides an avenue for moisture, that gets behind the exterior weather barrier, a means to escape.

In one embodiment, this invention relates to an in-plane, drainable, weather-resistive insulation sheathing, comprising an insulation foam and an insulation facer on at least one side of the insulation sheathing, wherein the insulation facer is adhered to the insulation foam, and wherein the insulation facer comprises an embossed design for moisture drainage.

In another embodiment, this invention relates to the insulation sheathing as described above, wherein the embossed design is in the same plane as the insulation sheathing plane.

In yet another embodiment, this invention relates to the insulation sheathing as described above, wherein the insulation facer is only on one side of the insulation sheathing.

In one embodiment, this invention relates to the insulation sheathing as described above, wherein the embossed design is on the insulation facer.

In another embodiment, this invention relates to the insulation sheathing as described above, wherein the embossed design is a geometric design, regular design and/or a random design.

In yet another embodiment, this invention relates to the insulation sheathing as described above, comprising a polymeric material.

In one embodiment, this invention relates to the insulation sheathing as described above, wherein the polymeric material is a thermoplastic resin that is polystyrene, polyisocyanurate, polyolefin, or polyurethane foams and beads.

In another embodiment, this invention relates to the insulation sheathing as described above, wherein the insulation facer comprises a plastic film, a thin metal foil, a paper or thin cellulose, a non-woven polymeric fabric, a fiberglass scrim, and combinations of the foregoing.

In yet another embodiment, this invention relates to a first insulation sheathing panel, comprising:
(i) an insulation foam layer having an outer surface and an inner surface, and
(ii) a first insulation facer having an outer surface and an inner surface,
wherein the inner surface of the first insulation facer is adhered to the inner surface of the insulation foam layer;
wherein the first insulation facer exceeds the dimension of the insulation foam layer at least at one edge to create an extension flap of the insulation facer, wherein the extension flap further comprises a removably attached release liner attached to the insulation facer's inner surface.

In one embodiment, this invention relates to the extension flap as recited above, wherein the insulation facer extends in length from about 0.5% of the minimum dimension of the insulation sheathing panel to about 50% of the length of the maximum dimension of the insulation sheathing panel.

In one embodiment, this invention relates to the extension flap as recited above, wherein the adhesive on the inner surface of the first insulation facer that adheres to the foam layer is the same as the adhesive on the extension flap of the insulation facer having a removably attached release liner.

In one embodiment, this invention relates to an insulation sheathing system comprising two insulation sheathing panels, a first insulation sheathing panel and a second insulation sheathing panel, wherein the two panels are juxtaposed side by side in one plane, wherein each panel comprises at least one extension flap with a backing of a release liner, at least on one side of the panel.

In one embodiment, this invention relates to an insulation sheathing system as recited above, wherein the two panels are fitted or attached to each other via the extension flap arrangement, with the release liner now removed and the extension flap extending from one panel to the second panel and providing the joining of the two panels.

In one embodiment, this invention relates to an insulation sheathing system as recited above, comprising two insulation sheathing panels: a first insulation sheathing panel and a second insulation sheathing panel, wherein the panels are juxtaposed side by side in one plane, wherein each panel comprises either a groove or a tongue at least on one side of the panel.

In one embodiment, this invention relates to an insulation sheathing system as recited above, wherein the two panels are fitted or attached or joined to each other via the tongue-and-groove arrangement.

In one embodiment, this invention relates to an insulation sheathing system as recited above, wherein the tongue and the groove are a continuous feature along the length of a panel in the system comprising at least two insulation sheathing panels.

In one embodiment, this invention relates to an insulation sheathing system as recited above, wherein the tongue and the groove arrangement is discrete such that each tongue is divided into multiple protrusions along the length of the side of a panel, and the corresponding side of the receiving panel comprises multiple grooves in form of depressed troughs to receive the multiple protrusions.

In one embodiment, this invention relates to a process for preparing a continuous insulation sheathing as recited above, comprising providing polystyrene for the insulation sheathing process, attaching the insulation facer on to the insulation sheathing, and embossing a design on the insulation facer side of the continuous insulation sheathing.

In another embodiment, this invention relates to a process as recited above, wherein the embossing step is performed under elevated pressure and/or elevated temperature.

In yet another embodiment, this invention relates to a process as recited above, wherein the embossed design is in the same plane as the insulation sheathing plane.

In one embodiment, this invention relates to a process as recited above, wherein the insulation facer is only on one side of the insulation sheathing.

In another embodiment, this invention relates to a process as recited above, wherein the embossed design is on the insulation facer.

In yet another embodiment, this invention relates to a process as recited above, wherein the embossed design is a geometric design, regular design and/or a random design.

In one embodiment, this invention relates to a process as recited above, comprising a polymeric material.

In another embodiment, this invention relates to a process as recited above, wherein the polymeric material is a thermoplastic resin that is polystyrene, polyisocyanurate, polyolefin, or polyurethane foams and beads.

In yet another embodiment, this invention relates to a process as recited above, wherein the insulation facer comprises a plastic film, a thin metal foil, a paper or thin cellulose, a non-woven polymeric fabric, a fiberglass scrim, and combinations of the foregoing.

In one embodiment, this invention relates to the insulation sheathing prepared by the process as recited above.

In another embodiment, this invention relates to a moisture collection and drainage system within an exterior stucco wall construction comprising an insulation sheathing as recited above.

In yet another embodiment, this invention relates to the moisture and drainage system above, wherein the embossed design comprises vertical channels.

### BRIEF DESCRIPTION OF THE DRAWINGS

FIG. 1 describes an insulation sheathing comprising an insulation foam and an insulation face.

FIG. 2 describes an insulation sheathing with an embossed design on the insulation facer.

FIG. 3 describes a process for preparing the insulation sheathing with an embossed design on the insulation facer.

FIG. 4 describes a finished insulation sheathing comprising an embossed pattern for water drainage on the insulation sheathing that has been prepared in the continuous in-line process.

FIG. 5 is the schematic of the tongue-and-groove extension in a panel.

FIG. 6 is the schematic of the tongue-and-groove extension in a non-continuous form in a panel.

FIG. 7 is the schematic of a panel with various examples of an extension flap with a release liner.

### DETAILED DESCRIPTION OF THE INVENTION

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an endpoint of a range, the disclosure should be understood to include the specific value or endpoint referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

### Insulation Foam

Thermal insulation sheathing offers thermal barrier properties desirable for enclosures having regulated temperatures, including houses, offices, refrigerated containers, and the like. Extruded polymer foam articles such as polystyrene foam boards are thermal insulation materials for use in such enclosures including building and construction applications as well as thermal insulation containers. See for example, WO2018098570A1.

The thermal insulation sheathing that can be cut up into boards are commonly used to enhance insulation of building structures. Relatively thin (about ¼ inch to about 3.0 inches), rectangular panels of foam board are commonly placed between the dry wall and building exteriors such as stone, brick, wood, stucco, and the like. Insulation boards employed in such applications may include, but are not limited to, those utilizing polyisocyanurate foam and extruded polystyrene, polyolefin, and polyurethane foams and beads.

It would be advantageous if such insulation sheathing also provided a weather-resistive barrier that aids in removal of moisture and waterproofing. The thermal insulation sheathing comprises foams of thermoplastic resins such as, for example, polystyrene, polyethylene, and polyurethane. Foams can be open-celled, close-celled and/or a mixed-cell structure. In one embodiment, the insulation foams are made of extruded polystyrene, expanded polystyrene, polyethylene, polypropylene, or polyurethane. In another embodiment, the insulation foams are made of are polyurethane foams, polyurea foams, blown polyvinylchloride foams, polyethylene foams, polypropylene foams, and combinations thereof.

They are useful industrial products because of their excellent heat-insulating, cushioning and other properties. These foams have found acceptance over the years in such applications as thermal insulation and cushioning as well as raw material for the fabrication of various shaped articles. The preparation of thermoplastic foams by extruding a heat-plastified mixture of a thermoplastic resin and a blowing agent is well known in the art and is described in U.S. Pat. Nos. 2,740,157; 3,067,147; 3,413,387; 3,413,388; 3,431,163; 3,431,164; 3,954,929 and 3,966,381 and Canadian Pat. No. 451,864. Similarly, various methods of preparing open or close-celled expanded polystyrene and other thermoplastic resins are described in art such as U.S. Pat. Nos. 3,243,485; 3,922,328; 4,399,086; 5,049,328; 5,271,886; and 7,358,280; U.S. Pat. App. Pub. Nos. US20020117769, US20130266766; and EPO patents EP242191A2 and EP1995273A2. All art cited in this document is incorporated by reference as if fully set forth herein.

Current weather-resistive barriers that claim drainage capability are sheet films that have an external application of adhesive or coating that provides an offset for potential drainage.

In U.S. Pat. No. 6,355,333, granted to Waggoner et al., a Construction Membrane is taught. The membrane is described as resisting liquid and air penetration, being moisture vapor permeable, and being provided with integral drainage channels. The disclosed exterior wall construction which incorporates this membrane may be faced with stucco, siding, brick, or stone.

An Exterior Building Cladding Having Rigid Foam Layer With Drain Channels is shown in U.S. Pat. No. 6,886,301, granted to Schilger. Both the inside and the outside faces of the rigid foam insulation layer are provided with vertical channels 21 to remove moisture by way of thin channels 22. Exterior water penetration drains to the bottom of channels 22, and exits the wall construction by means of a drain wick 28 and flashing 25.

In Published Patent Application No. US 2011/0296781, owned by McCary, an Insulating Finishable Panel is illustrated. This construction employs a rigid-faced foam cored panel, which, in one embodiment includes foam air spacers adhered to the panel's radiant reflective surface. In another arrangement, attached foam air spacers create an air space between the insulation and the radiant reflective surface.

In Published Patent Application No. US 2008/0034690, to Gartz et al., an Underlayment With Improved Drainage is disclosed. The underlayment may include a plurality of vertical channels, and funnels at respective top and bottom edges. The funnels are provided to compensate for misalignment of vertically stacked underlayment panels.

Notwithstanding coats of paint and moisture sealant applied to the exterior layer of a stucco wall, moisture still manages to penetrate the stucco over time, and collect on layers of material within the wall. Known prior art construction methods provide moisture barriers and attempt to allow the drainage of accumulated moisture. However, these methods have proven inadequate, and stucco walls continue to fail from moisture intrusion and accumulation, allowing mold to form and causing wood to rot. The exterior stucco wall construction disclosed herein, provides improved drainage of the moisture which has penetrated the wall and collects therein on materials and structures. Improved longevity and integrity of the stucco wall system is thereby provided.

The insulation layer can comprise any suitable insulation material conventionally known to one of ordinary skill in the art. For example, the insulation layer can comprise a foam polymer insulation, including for example and without limitation, polyisocyanurate foam, polystyrene foam, polyurethane foam, or any combination thereof. In further exemplary aspects, the foam insulation layer comprises polyisocyanurate foam. In still further aspects, the foam insulation layer can comprise a blend or combination of a polyisocyanurate and polyurethane foam.

The foam insulation layer can comprise extruded foam, expanded foam, or a combination thereof. As one of ordinary skill in the art will appreciate, extruded foams can be prepared by melting a suitable polymer material, incorporating a blowing agent to yield a foamed gel, and extruding the foamed gel through a die to form the desired foam layer. Expanded foams can be prepared by subsequent expansion of beads containing a blowing agent, wherein the expanded beads are molded at the time of expansion to form the desired foam layer.

The foam insulation can have any desired density. For example, the foam insulation can have a density of at least about 1, 2, 3, 4, 5, 6, 7, 8, 9, 10 , 11, 12, 13, 14, 15, 16, 17, 18, 19, or even at least about 20 pounds per cubic feet (pcf) according to ASTM D1622. In further aspects, the foam insulation can have a density in the range of about 1 pcf to about 20 pcf. In still further aspects, the foam insulation density can be any desired value within any range derived from any of the above exemplified values, including, for example, a density in the range from about 2 to about 5 pcf, or from about 1 to about 10 pcf.

The foam insulation can be either closed cell or open cell. Open cell foam is more likely to let water vapor condense inside the cells, thereby reducing the insulation value. Thus, in further exemplary aspect, the foam insulation is closed cell. In a further aspect, the foam insulation is greater than about 50, 60, 70, 80, or even greater than about 90% closed-cell according to ASTM D2856.

Since water can negatively impact thermal performance, the foam insulation preferably exhibits limited or substantially no water absorption. For example, the foam insulation exhibits a water absorption of less than about 10, 9, 8, 7, 6, 5, 4, 3, 2, or even less than about 1% according to ASTM C209. In a further aspect, the foam insulation exhibits a water absorption of less than about 10, 9, 8, 7, 6, 5, 4, 3, 2, or even less than about 1% according to ASTM C2842. In a still further aspect, the foam insulation can exhibit a water absorption in the range of about 10 to about 0%. In a yet further aspect, the water absorption can be any desired value within any range derived from any of the above exemplified values, including, for example, a water absorption in the range from about 0 to about 5%, or from about 1 to about 3.5%.

Moreover, the foam insulation layer can have any desired water vapor permeance (or transmission) value. For example, the water vapor permeance can be about 20, 15, 10, 9, 8, 7, 6, 5, 4, 3, 2, 1, or even about 0 perms according to ASTM E96. In a further aspect, the water vapor permeance can be in the range of about 0 to about 20 perms. In a still further aspect, the water vapor permeance can be any desired value within any range derived from any of the above exemplified values, including, for example, a water vapor permeance in the range from about 0 to about 2 perms, or from about 1 to about 5 perms.

The insulation layer can have any desired thickness (t). This thickness (t) can be customized to fit any particular application and desired thermal resistance. For example, and without limitation, the thickness of the foam insulation layer can be in the range of from about 0.25 in. (¼″) to 3 in. (3″). In further aspects, the thickness can be from about 0.5 in. to about 1 in. Depending on the intended application, the panel can have any desired thermal resistance value (R-value). For example, the panel can have a R-value of at least about 1, 2, 3, 4, 5, 6, 7, 8, 9, 10, 15, 20, 25 according to ASTM C1289-02. In a further aspect, the R-value can be in the range of about 1 to about 25. In still further aspects, the R-value can be any desired value within any range derived from any of the above exemplified values, including, for example, R-value in the range from about 1 to about 10, or from about 3 to about 7.

In various aspects, the insulation layer can optionally comprise a membrane layer. The insulation membrane layer can comprise radiant barrier material, such as metal foil, for example, aluminum foil, polymeric film or fabric, paper or cellulosic material, reinforcing scrim, such as fiberglass scrim, or a combination thereof. In some aspects, the membrane layer comprises a single or multi-layered material which can be a laminate in which a backing material is laminated to a foam insulation layer. In other aspects, one or more optional additives can also be incorporated into or otherwise applied to the foam insulation layer. Exemplary and non-limiting additives can include flame retardants, colorants, ultraviolet absorbers, textured coatings, and the like as well as any combinations thereof.

The insulation layer can be secured to the inward facing surface of the panel, for example, by any conventionally used adhesive material known in the art to be compatible for use with foam insulation. For example, according to non-limiting aspects of the invention, the adhesive can be selected from a phenol-formaldehyde resin, hot-melt adhesive, polyvinyl acetate (PVA) resin, or any combination thereof. In still a further aspect, the adhesive can be isocyanate-based.

The insulated panels disclosed herein can exhibit improved physical strength and durability over traditional sheathing panels or foam panels. Thus, in one aspect, the inventive insulated panels can exhibit enhanced structural strength and dimensional stability when compared to a conventional or reference sheathing panel in the absence of the insulation layer when exposed to substantially the same environmental and/or physical forces under substantially similar conditions. To that end, the foam insulation layer can have a dimensional stability of about less than 5, 4, 3, 2, or even less than about 1% according to ASTM D2126. In a further aspect, the dimensional stability is preferably about less than 2%. The foam insulation layer can also have any desired compressive strength. For example, the foam insulation layer can have a desired compressive strength of at least about 1, 5, 10, 15, 20, 25, 30, 35, 40 pounds per square inch (psi) according to ASTM D1621. In a further aspect, the compressive strength can be in the range of about 1 to about 40 psi. In a still further aspect, the compressive strength can be any desired value within any range derived from any of the above exemplified values, including, for example, a compressive strength in the range from about 15 to about 30 psi, or from about 20 to about 25 psi. Likewise, the foam insulation layer can have any desired tensile strength. For example, the foam insulation layer can have a tensile strength of greater than about 300, 400, 500, 600, 700, 800, 900, 1000, 1500, 2000 pounds per cubic foot (pcf) according to ASTM D1623. In a further aspect, the tensile strength can be in the range of about 300 to about 2000 pcf. In a still further aspect, the tensile strength can be any desired value within any range derived from any of the above exemplified values, including, for example, a tensile strength in the range from about 500 to about 1000 pcf, or from about 600 to about 800 pcf.

In further aspects, the structural properties of the disclosed insulated panels make the insulated panels suitable for use in numerous structural applications, while still providing improved thermal performance. For example, in one aspect, the inventive insulated panels can be used as braced wall panels, when used in accordance with 2006 IBC Section 2308.3 and 2006 IRC Section R602.10.1. In another aspect, the inventive insulated panels are considered equivalent to Construction Method 3 described in Section 2308.9.3 of the 2006 IBC and Section R602.10.3 of the 2006 IRC. In another aspects, the inventive insulated panels are suitable for use an alternative to wood structural panels in the construction of wood shear walls, when installed in accordance with 2006 IBC Section 2305.3.

It should be noted that all references cited above, and otherwise, in this specification are incorporated in this specification as if they were fully set forth herein.

In one embodiment, the foam insulation is expanded Polystyrene (EPS), Extruded Polystyrene (XPS), Graphite Polystyrene (GPS), or polyisocyanurate foam insulation.

Expanded Polystyrene Insulation, more commonly referred to as EPS, is a closed cell insulation made commonly with of 98% trapped air and only 2% plastic. In one embodiment, this invention relates to a flat board, a contoured shape, or a combination of flat and contoured shaped EPS.

Extruded Polystyrene, referred to as XPS, is a closed cell insulation product commonly used in remodeling and new construction applications. In one embodiment, this invention relates to a flat board, a contoured shape, or a combination of flat and contoured shaped XPS.

Graphite polystyrene insulation, or GPS, is made from Neopor beads, patented and manufactured by BASF. Neopor gives GPS insulation a dark gray appearance and higher r-value than traditional EPS insulation products. In one embodiment, this invention relates to a flat board, a contoured shape, or a combination of flat and contoured shaped GPS.

Polyisocyanurate foam boards may include closed-cell polyisocyanurate (polyiso) foam insulation. This is described, for example, in U.S. Pat. No. 10,829,939B2, which is incorporated by reference herein.

In one embodiment, this invention relates to a system of panels described herein, wherein at least one panel comprises EPS, or at least one panel comprises XPS, or at least one panel comprises GPS, or at least one panel comprises polyisocyanurate foam, or at least a combination of two out of the four panels, three of the four panels, or all four panels. In another embodiment, the panels may be organized adjacent each other or separate from each other.

### Insulation Facers

A problem encountered when using thin insulation sheathing is physical damage from bending, impact, or breaking. Such damage may occur by acts of vandalism, high velocity winds, rain, hail, construction practices, and the like. For example, in construction, it is common for ladders placed against vertical walls to bend, damage, or even break the insulation sheathing. It is also common for construction personnel to kneel upon insulation boards during construction.

Also, foam insulation boards are subjected to oxygen-and water-vapor-transmission and structural damage, both of which, over time, contribute to deteriorating the insulation properties and reducing the structural integrity of the board. A technique to address the problems of physical damage and loss of insulation properties is to apply or adhere a facing material (called a “facer”) to at least one side of the board. Examples of such facing materials include plastic film, thin metal foil, paper or thin cellulose, non-woven polymeric fabrics, fiberglass scrims, and combinations of the foregoing.

Important properties of facers include serving as moisture vapor and oxygen transmission barriers, providing strength and structural integrity, ease of application, etc. Thin metal foils, such as aluminum, are commonly utilized in facers to provide moisture-vapor-and oxygen-transmission barrier properties.

Many laminates and/or facers for use in covering foam insulation boards and other products are described in the prior art. Such laminates are described in U.S. Pat. Nos. 6,872,673; 6,355,701; 6,093,481; 6,044,604; 5,695,870; 5,565,252; 5,345,738; 5,044,705; 4,985,106; 4,764,420; 4,572,865; 4,509,307; 4,284,674; 4,254,173; and 3,903,346. It is desirable to provide a laminate and/or facer for uses that require improved oxygen-and moisture-vapor barrier properties, structural integrity, strength, and weatherability.

### Geometric Pattern

By geometric pattern is mean vertical lines, horizontal lines, transverse lines, crisscross lines, lattice, circles, triangles, squares, rectangles, trapezoid, rhombus, pentagons, and other such geometric designs. More than one type of geometric structure may be present on the surface of the insulation facer in an embossed or recessed fashion.

### Regular Pattern

By a regular pattern is meant that the same pattern is repeated in partial or full surface of the insulation facer. In other words, a geometric pattern would be repeated, or an irregular pattern would be repeated.

### Irregular Pattern

By irregular pattern is meant the insulation facer has a random design that is not regular.

### Embossing

By embossing herein is meant a relative difference in depth between the embossed pattern and the recessed pattern on the surface of the insulation facer. For example, if a pattern is embossed on the insulation facer surface, it covers the aspect where the same design is embossed or recessed.

### Tongue-and-Groove Arrangement

In an insulation sheathing panel, at least on one side of the panel either a tongue or a groove can be provided for its juxtaposition and attachment to an adjacent panel. By tongue is meant a protrusion along the length of the side of a panel that removably fits within the groove of an adjacent panel. By groove is meant a depression along the length of an insulation sheathing panel which allows for a removable attachment of the side of an adjacent panel that has a tongue along its length.

Generally, separate steps are needed to create a system that is insulative, vapor semi-permeable, a weather resistive barrier, and acts as a drainage plane. The steps may include exterior insulation and a weather-resistive barrier that may or may not meet drainage needs through an outward facing attachment to the film, and placing an additional medium to the wall system to promote drainage.

As discussed previously, the present invention, a vapor semi permeable weather resistive drainage product is created in a single inline process through an embossment technique. Particularly, the present invention provides for a vapor semi-permeable insulation sheathing that provides insulation, a weather resistive barrier and air barrier while providing a drainage mechanism that is formed through pressure and heat. The patterned embossment on the sheathing provide an avenue for moisture that gets behind the exterior weather barrier a means to escape.

In one embodiment, this invention relates to an in-plane, drainable, weather-resistive insulation sheathing, comprising an insulation foam and an insulation facer on at least one side of the insulation sheathing, wherein the insulation facer is adhered to the insulation foam, and wherein the insulation facer comprises an embossed design for moisture drainage.

In one embodiment, this invention relates to a first insulation sheathing panel, comprising:
(i) an insulation foam layer having an outer surface and an inner surface, and
(ii) a first insulation facer having an outer surface and an inner surface,
wherein the inner surface of the first insulation facer is adhered to the inner surface of the insulation foam layer;
wherein the first insulation facer exceeds the dimension of the insulation foam layer at least at one edge to create an extension flap of the insulation facer, wherein the extension flap further comprises a removably attached release liner attached to the insulation facer's inner surface.

In one embodiment, the extension flap of the insulation facer extends in length from about 0.5% of the minimum dimension of the insulation sheathing panel to about 50% of the length of the maximum dimension of the insulation sheathing panel. In one embodiment, the adhesive on the inner surface of the first insulation facer that adheres to the foam layer is the same as the adhesive on the extension flap of the insulation facer having a removably attached release liner.

In one embodiment comprising the extension flaps or pre-applied tapes, the overhang is anywhere from 0.1 inches to 12 inches on any one or more edges of the panel. This is advantageous is minimizing or to eliminating the need for labor to tape the seams in the field.

In one embodiment, the length of the extension flaps or pre-applied tapes can be any one number of the following numbers, or can be a number within a range defined by any two numbers below, including the endpoints of such range, as measured in inches: 0.1, 0.2, 0.5, 1, 2, 3, 4, 5, 6, 7, 8, 9, 10, 11, and 12.

In one embodiment, this invention relates to a insulation sheathing system that comprises two insulation sheathing panels: a first insulation sheathing panel and a second insulation sheathing panel. The two panels are juxtaposed side by side in one plane. Each insulation sheathing panel comprises the insulation foam layer and the insulation facer as described previously. In one embodiment, the insulation sheathing system comprises the two panels wherein each panel comprises at least one extension flap with a backing of a release liner, on one side of the panel. In another embodiment, the two panels are fitted or attached to each other via the extension flap arrangement, with the release liner now removed and the extension flap extending from one panel to the second panel and providing the joining of the two panels. Multiple panels can be similarly joined.

In one embodiment, the extension flap is continuous along the length of the side of the insulation panel from which it extends outward. In another embodiment, of the invention, the extension flap is discrete, with multiple protrusions which in totality make the extension flap. In one embodiment, there is a gap between the protrusions that form the extension flap. In another embodiment, the protrusions are of the same width or of different widths.

In one embodiment, the tongue and the groove are a continuous feature along the length of a system comprising at least two insulation sheathing panels. In another embodiment of the insulation sheathing panel systems, the tongue and the groove arrangement is discrete such each tongue is divided into multiple protrusions along the length of the side of a panel, and the corresponding side of the receiving panel comprises multiple grooves in form of depressed troughs to receive the multiple protrusions. In one system, the tongue is discrete on one sheathing panel, but the receiving groove is continuous.

In one embodiment, this invention relates to a insulation sheathing system that comprises two insulation sheathing panels: a first insulation sheathing panel and a second insulation sheathing panel. The two panels are juxtaposed side by side in one plane. Each insulation sheathing panel comprises the insulation foam layer and the insulation facer as described previously. In one embodiment, the insulation sheathing system comprises of the two panels wherein each panel comprises either a groove or a tongue at least on one side of the panel. In another embodiment, the two panels are fitted or attached or joined to each other via the tongue-and-groove arrangement. Multiple panels can be similarly joined.

In one embodiment, the tongue and the groove are a continuous feature along the length of a system comprising at least two insulation sheathing panels. In another embodiment of the insulation sheathing panel systems, the tongue and the groove arrangement is discrete such each tongue is divided into multiple protrusions along the length of the side of a panel, and the corresponding side of the receiving panel comprises multiple grooves in form of depressed troughs to receive the multiple protrusions. In one system, the tongue is discrete on one sheathing panel, but the receiving groove is continuous.

In one aspect of the invention, the invention relates to an insulation sheathing panel or an insulation sheathing system (i.e., multiple panels), that have panels comprising both the extension flaps and the tongue-and-groove arrangement.

In one embodiment, the insulation sheathing panel has more than 2 sides. Stated differently, the present invention envisions a panel comprising, the following sides: 3, 4, 5, 6, 7, 8, 9, 10, 11, 12, 13, 14, 15, 16, 17, 18, 19, 20.

In one embodiment of the invention, the panel has a curved shape, for example, it is circular, or oblong shaped or a semi-circle shaped. In one embodiment of the invention, the panel has at least one side that is not linear, but has a curved shape.

In one embodiment, the multiple-sided panel has all sides that are equal or at least two sides that are equal or no sides that are equal in length.

This invention envisions an insulation sheathing panel system comprising at least two panels wherein a first panel is irregular shaped, but the adjacent juxtaposing second panel neatly fits with the irregular shape of the first panel. In one embodiment, the insulation panel system comprises more than one square or a rectangular panel, wherein each side of the panel has a tongue or groove configuration and each side has an extension flap of the insulation facer with the releasable liner backing.

In one embodiment, this invention relates to an insulation sheathing panel, comprising:
(iii) an insulation foam layer having an outer surface and an inner surface,
(iv) a first insulation facer having an outer surface and an inner surface, and optionally,
(v) a second insulation facer having an outer surface and an inner surface;
wherein the inner surface of the first insulation facer is adhered to the inner surface of the insulation foam layer;
wherein the inner surface of the second insulation facer is adhered to the outer surface of the insulation foam layer;
wherein the first insulation facer exceeds the dimension of the insulation foam layer at least at one edge to create an extension flap of the insulation facer, wherein the extension flap further comprises a removably attached release liner attached to the insulation facer's inner surface.

In one embodiment, the pattern on the insulation facer will also repeat in the machine direction of the insulation sheath being made. In one embodiment, the embossed design connects with each other for adequate drainage of the moisture. In one embodiment, the embossed design is vertical lines. In one embodiment, the embossed design is crisscross lines or a lattice design. In one embodiment, the design is rhombus or diamond shape. In one embodiment, the entire design is connected to each other. In one embodiment the design is a set of transverse lines. It is to be understood that the designs and/or patterns herein are in plurality and/or in repetition in the vertical or the horizontal (machine) direction.

This invention addresses the above issues of moisture drainage by providing a vapor semi permeable weather resistive drainage product in a single inline process through an embossment technique.

Particularly, in one of its embodiments, it includes a vapor semi-permeable insulation sheathing that provides insulation, a weather-resistive barrier, and an air barrier while simultaneously providing a drainage mechanism on the external surface, that has been engendered through an in-line application of pressure and heat. The patterned embossment on the sheathing provide an avenue for moisture that gets behind the exterior weather barrier a means to escape.

The comprehensive weather resistive barrier that includes an insulation component with an embossed drainage system allows the contractor minimal passes to create all functions while using a planar board that does not exceed the primary dimension of the sheathing. The design uses a polymeric film that is breathable and adhered to an insulative core material through heat lamination on one face that undergoes pressure and heat to create a mechanism to promote drainage when used a s a wall system component. The patterned embossment in the sheathing will provide an avenue for moisture that gets behind the exterior weather barrier a means to escape.

In the present disclosure, insulation sheathing, insulation board, insulation panel, or insulation material is used interchangeably.

As discussed previously, insulation facing laminations are laminates which contain film/foil or metalized films that provide protection for a variety of insulation applications. Often the adhesive possesses fire-retardant properties. Typical applications include ceiling panels and wall insulation.

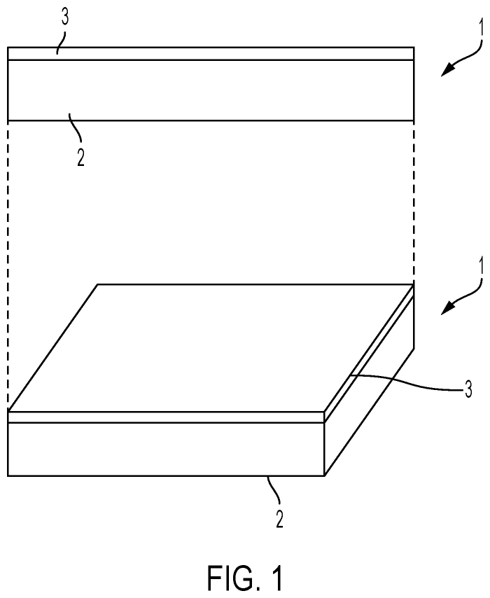

As shown in FIG. 1, and in one embodiment, the insulation sheathing (1) comprises an insulation foam (2) and an insulation facer (3) laminated on at least one surface of the insulation foam (2).

In one embodiment, such facing materials or insulation facers include plastic film, thin metal foil, paper or thin cellulose, non-woven polymeric fabrics, fiberglass scrims, and combinations of the foregoing.

In one embodiment, the insulation sheathing includes extruded polystyrene, polyisocyanurate, polyolefin, and polyurethane foams and beads.

The insulation facer comprises an embossed pattern on its surface. The pattern may be geometric, regular, or random. The embossed pattern is such that it aids in draining of the accumulating moisture on the surface of the insulation sheathing.

By geometric pattern is mean vertical lines, horizontal lines, transverse lines, circles, triangles, squares, rectangles, trapezoid, rhombus, pentagons, and other such geometric designs. More than one type of geometric structure may be present on the surface of the insulation facer in an embossed or recessed fashion.

By a regular pattern is meant that the same pattern is repeated in partial or full surface of the insulation facer. In other words, a geometric pattern would be repeated, or an irregular pattern would be repeated.

By irregular pattern is meant the insulation facer has a random design that is not regular.

By embossing herein is meant a relative difference in depth between the embossed pattern and the recessed pattern on the surface of the insulation facer. For example, if a pattern is embossed on the insulation facer surface, it covers the aspect where the same design is embossed or recessed.

The pattern will also repeat in the machine direction of the insulation sheath being made.

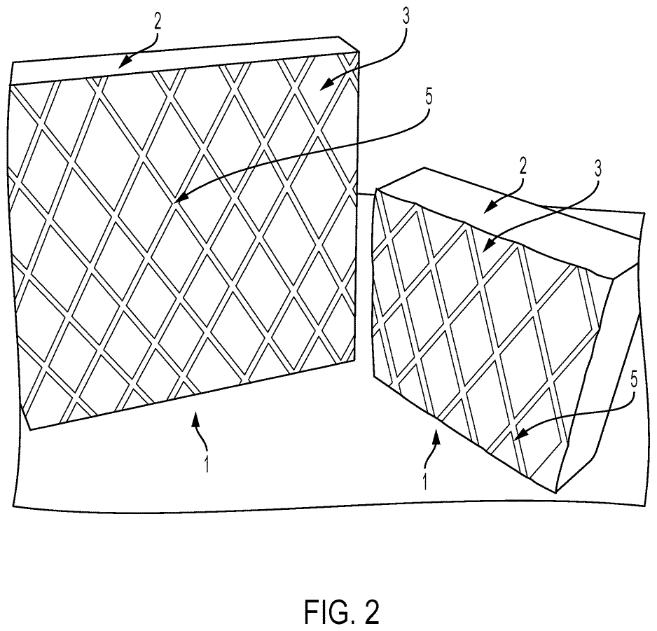

The embossed design (5) on the insulation sheathing (1) is such that insulation sheathing of the present invention has an advantageous moisture drainage or removal possibility. An embossed design is shown in FIG. 2.

In one embodiment, this invention relates to an exterior stucco wall construction comprising: a wall frame; sheathing attached to the outer side of the wall frame; a moisture collection channel or the embossed design mounted along the insulation sheathing facer, a second moisture impervious board comprising the insulation sheathing having an inner side insulation facer provided with drain means such as the embossed design described previously to facilitate the downward drainage of moisture.

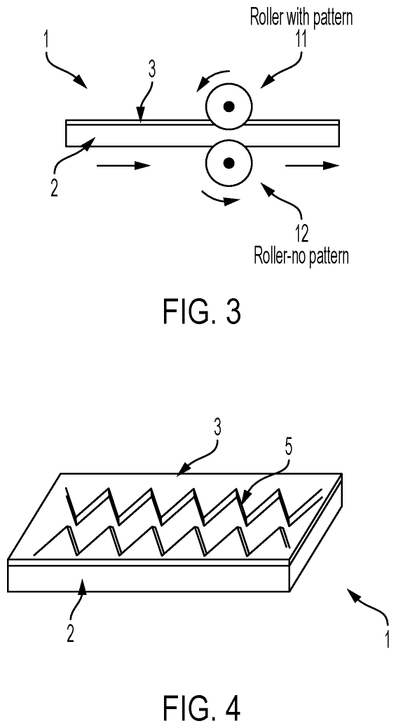

Turning now to the drawings, and in particular FIG. 3 shows the process of embossing the design on the insulation facer (3). At least one of the rollers (11 & 12) has a design template on its surface. The continuously moving insulation sheathing has an insulation facer (3) on one or both surfaces. The insulation sheathing (with the foam (2) and the facer (3)) moves in the horizontal direction, in one example, and under temperature and/or pressure, the embossed design is imprinted. As shown in FIG. 4, a design (5) for moisture removal is embossed on the facer (3) of the foam insulation. This embossed design (5) feature provides the maximum discharge of moisture and condensation. Experimentation includes creating a means to emboss the assembly while not deteriorating the weather resistive barrier or air barrier requirements. Further testing includes permeance, wind driven rain, R-Value, compatibility, drainage and pressure testing of the assembly.

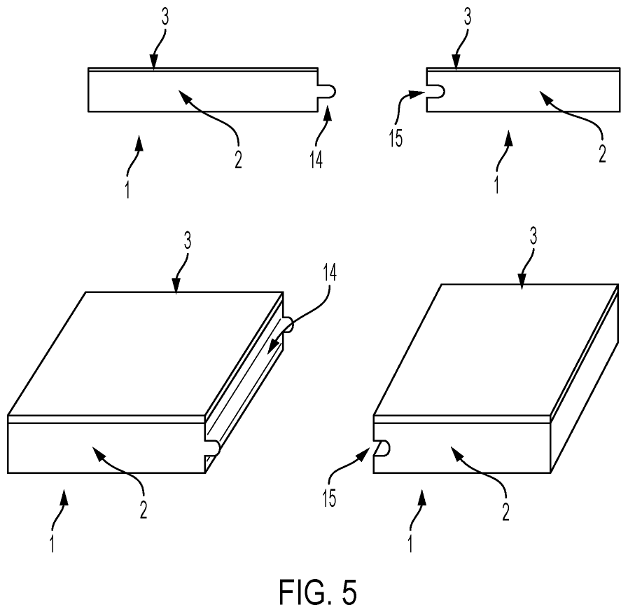

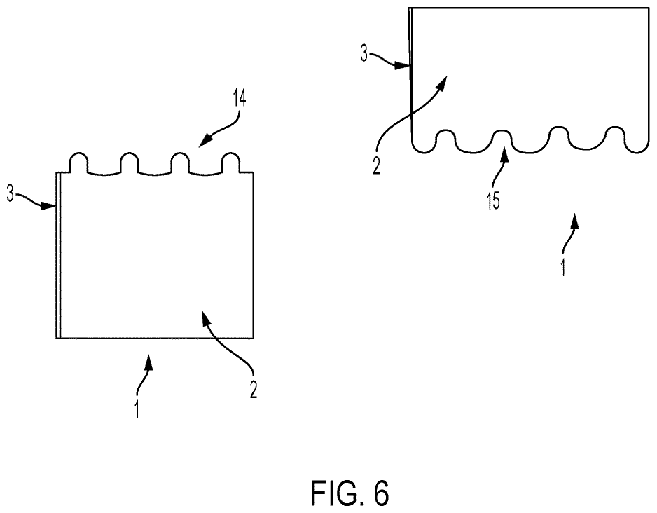

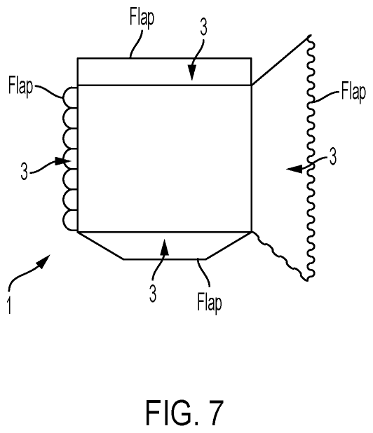

FIG. 5 shows an embodiment of a panel (1) with tongue (14) and groove (15). FIG. 6 shows an embodiment of a panel (1) with multiple tongues (14) and multiple grooves (15). FIG. 7 shows a panel (1) with four embodiments of flaps (21).

### EXPERIMENTAL

In one embodiment, a pattern roller is applied to a rotary press. The sheet of foam which is laminated in line previously enters the roller with ¼″ pinch which creates pressure at a temperature in excess of 220°F. The pressure roller is spinning at 60 feet per minute. The material exits the roll and the pattern is embossed in the insulation sheathing on the facer side.

1. An in-plane, drainable, weather-resistive insulation sheathing, comprising an insulation foam and an insulation facer on at least one side of the insulation sheathing, wherein the insulation facer is adhered to the insulation foam, and wherein the insulation facer comprises an embossed design for moisture drainage.

2. The insulation sheathing as described in claim 1, wherein the embossed design is in the same plane as the insulation sheathing plane.

3. The insulation sheathing as recited in claim 1, wherein the insulation facer is only on one side of the insulation sheathing.

4. The insulation sheathing as recited in claim 1, wherein the embossed design is on the insulation facer.

5. The insulation sheathing as recited in claim 4, wherein the embossed design is a geometric design, regular design and/or a random design.

6. The insulation sheathing as recited in claim 1, comprising a polymeric material.

7. The insulation sheathing as recited in claim 6, wherein the polymeric material is a thermoplastic resin that is polystyrene, polyisocyanurate, polyolefin, or polyurethane foams and beads.

8. The insulation sheathing as recited in claim 1, wherein the insulation facer comprises a plastic film, a thin metal foil, a paper or thin cellulose, a non-woven polymeric fabric, a fiberglass scrim, and combinations of the foregoing.

9. A first insulation sheathing panel, comprising:
(i) an insulation foam layer having an outer surface and an inner surface, and
(ii) a first insulation facer having an outer surface and an inner surface,
wherein the inner surface of the first insulation facer is adhered to the inner surface of the insulation foam layer;
wherein the first insulation facer exceeds the dimension of the insulation foam layer at least at one edge to create an extension flap of the insulation facer, wherein the extension flap further comprises a removably attached release liner attached to the insulation facer's inner surface.

10. The extension flap as recited in claim 9, wherein the insulation facer extends in length from about 0.5% of the minimum dimension of the insulation sheathing panel to about 50% of the length of the maximum dimension of the insulation sheathing panel.

11. The extension flap as recited in claim 9, wherein the adhesive on the inner surface of the first insulation facer that adheres to the foam layer is the same as the adhesive on the extension flap of the insulation facer having a removably attached release liner.

12. An insulation sheathing system comprising two insulation sheathing panels, a first insulation sheathing panel and a second insulation sheathing panel, wherein the two panels are juxtaposed side by side in one plane, wherein each panel comprises at least one extension flap with a backing of a release liner, at least on one side of the panel.

13. The insulation sheathing system as recited in claim 12, wherein the two panels are fitted or attached to each other via the extension flap arrangement, with the release liner now removed and the extension flap extending from one panel to the second panel and providing the joining of the two panels.

14. An insulation sheathing system comprising two insulation sheathing panels: a first insulation sheathing panel and a second insulation sheathing panel, wherein the panels are juxtaposed side by side in one plane, wherein each panel comprises either a groove or a tongue at least on one side of the panel.

15. The insulation sheathing system as recited in claim 14, wherein the two panels are fitted or attached or joined to each other via the tongue-and-groove arrangement.

16. The insulation sheathing system as recited in claim 14 wherein the tongue and the groove are a continuous feature along the length of a panel in the system comprising at least two insulation sheathing panels.

17. The insulation sheathing system as recited in claim 14, wherein the tongue and the groove arrangement is discrete such that each tongue is divided into multiple protrusions along the length of the side of a panel, and the corresponding side of the receiving panel comprises multiple grooves in form of depressed troughs to receive the multiple protrusions.

18. A process for preparing a continuous insulation sheathing as recited in claim 1, comprising providing polystyrene for the insulation sheathing process, attaching the insulation facer on to the insulation sheathing, and embossing a design on the insulation facer side of the continuous insulation sheathing.

19. The process as recited in claims 18, wherein the embossing step is performed under elevated pressure and/or elevated temperature.

20. The process as recited in claim 19, wherein the embossed design is in the same plane as the insulation sheathing plane.

21. The process as recited in claim 19, wherein the insulation facer is only on one side of the insulation sheathing.

22. The process as recited in claim 19, wherein the embossed design is on the insulation facer.

23. The process as recited in claim 19, wherein the embossed design is a geometric design, regular design and/or a random design.

24. The process as recited in claim 19, comprising a polymeric material.

25. The process as recited in claim 24, wherein the polymeric material is a thermoplastic resin that is polystyrene, polyisocyanurate, polyolefin, or polyurethane foams and beads.

26. The process as recited in claim 19, wherein the insulation facer comprises a plastic film, a thin metal foil, a paper or thin cellulose, a non-woven polymeric fabric, a fiberglass scrim, and combinations of the foregoing.

27. The insulation sheathing prepared by the process as recited in claim 18

28. A moisture collection and drainage system within an exterior stucco wall construction comprising an insulation sheathing as recited in claim 1.

29. The moisture and drainage system of claim 28, wherein the embossed design comprises vertical channels.
